(19) United States
(12) Patent Application Publication
(10) Pub. No.: US 2024/0386243 A1
(43) Pub. Date: Nov. 21, 2024

(54) GENERATING PREDICTED ACCOUNT INTERACTIONS WITH COMPUTING APPLICATIONS UTILIZING CUSTOMIZED HIDDEN MARKOV MODELS

(71) Applicant: Adobe Inc., San Jose, CA (US)

(72) Inventors: Hsin-Ya Lou, San Jose, CA (US); Xiaojing Dong, Santa Clara, CA (US); Yuting Chen, San Jose, CA (US)

(21) Appl. No.: 18/320,466

(22) Filed: May 19, 2023

(51) Int. Cl. G06N 3/045

(52) U.S. Cl. CPC G06N 3/045

(57) ABSTRACT

The present disclosure relates to systems, non-transitory computer-readable media, and methods for predicting account interactions with computing applications. In particular, in one or more embodiments, the disclosed systems determine user account data associated with one or more computing applications for a user account. Additionally, in some embodiments, the disclosed systems generate, based on the user account data, a transition matrix and an emission matrix corresponding to a plurality of hidden states of a hidden Markov model to customize the hidden Markov model for the user account. Furthermore, in some implementations, the disclosed systems determine, utilizing the customized hidden Markov model, one or more predicted account interaction metrics for the user account in connection with the one or more computing applications based on the transition matrix and the emission matrix.

### BACKGROUND

Recent years have seen developments in hardware and software platforms managing access to and interactions with computing applications. For example, many entities provide user account management software to manage user accounts associated with client applications via various subscriptions. When managing access and interactions by many user accounts in connection with many different computing applications, each of which can have different sets of possible permissions, determining when a given user account is likely to interact with a particular computing application can be an important and challenging aspect of managing hardware and software resources and availability. To illustrate, accurately predicting account interactions with computing applications is critical to ensuring that sufficient server and network resources (e.g., computer memory, bandwidth) are available to handle processing loads associated with the use of the computing applications.

Some conventional application access systems utilize models to predict account interactions with computing applications. Such conventional systems suffer from a number of technical deficiencies, including inflexibility (by imposing rigid assumptions on the models that constrain the models to a small set of real-world applications), inaccuracy (by generating imprecise predictions), and inefficiency (by utilizing excessive data storage, memory, and computing resources).

For instance, conventional systems inflexibly constrain their prediction models with rigid and unrealistic assumptions. For example, conventional systems often utilize sub-models to predict factors that influence user account interactions, thereby limiting prediction model robustness because of variability of account interactions. Furthermore, conventional systems often utilize models (e.g., regression models) that yield only a single prediction value for a user account interaction, which is limited to a single computing application and a single time period. Additionally, conventional systems often cannot generate accurate predictions for time periods different from training dataset periods, thereby limiting prediction robustness for different time scales without training separate models for the different time scales.

Moreover, conventional systems inaccurately generate predictions of account interactions. In particular, conventional systems often lack in-depth insight into the dynamics of account interactions with computing applications, thereby missing interactions and yielding incomplete predictions. For instance, conventional systems often generate predictions that do not account for variations such as interactions by user accounts with subsets of computing applications. Inaccurately generating predictions of account interactions with computing applications results in inaccurate determinations of hardware, software, and network resource requirements for handling user account interactions for the computing applications.

Furthermore, conventional systems inefficiently generate predictions of account interactions. Specifically, conventional systems often require large datasets of historical data to generate meaningful predictions. For example, conventional systems often require years of historical account data to generate predictions of account interactions for future years, which can result in unreliable and outdated predictions given frequently inconsistent records maintained by entities. Processing such large amounts of data, conventional systems often expend excessive computing time and resources (e.g., memory, storage space, and processing bandwidth). Moreover, by processing large amounts of historical data, conventional systems often require extensive user interactions to preprocess, clean, and maintain historical data from multiple legacy systems, which can also lead to data inaccuracies, outdated predictions, and unreliable results.

These along with additional problems and issues exist with regard to conventional prediction systems.

### BRIEF SUMMARY

Embodiments of the present disclosure provide benefits and/or solve one or more of the foregoing or other problems in the art with systems, non-transitory computer-readable media, and methods for managing user account interactions with computing applications utilizing customized hidden Markov models. In some embodiments, the disclosed systems utilize individualized user account data to generate individual-level hidden Markov models for predicting the user account interactions with the computing applications. For instance, in some implementations, the disclosed systems utilize user account data of a user account to generate an initial hidden state probability matrix, a transition probability matrix, and an emission probability matrix for a customized hidden Markov model for the user account. To illustrate, in some embodiments, the disclosed systems generate the matrices for the customized hidden Markov model utilizing one or more neural networks. For example, in some cases, the disclosed systems generate the initial hidden state probability matrix utilizing an initial state neural network, the transition probability matrix utilizing a transition neural network, and the emission probability matrix utilizing an emission neural network. Furthermore, in some embodiments, the disclosed systems utilize the generated matrices of the customized hidden Markov model to determine one or more predicted account interaction metrics for the user account indicating predicted future interactions of the user account with one or more computing applications for one or more time periods.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which an account interaction prediction system operates in accordance with one or more embodiments.

FIG. 2 illustrates a flowchart of the account interaction prediction system determining a predicted account interaction metric in accordance with one or more embodiments.

FIG. 3 illustrates a flowchart for generating customized hidden Markov model matrices for a user account in accordance with one or more embodiments.

FIG. 4 illustrates a flowchart for generating customized hidden Markov model matrices for a user account utilizing one or more neural networks of the account interaction prediction system in accordance with one or more embodiments.

FIG. 5 illustrates a flowchart for generating customized hidden Markov model matrices for a plurality of user accounts in accordance with one or more embodiments.

FIG. 6 illustrates a diagram of an initial state matrix, a transition matrix, and an emission matrix of a hidden Markov model in accordance with one or more embodiments.

FIG. 7 illustrates a diagram of a hidden Markov model in accordance with one or more embodiments.

FIG. 8 illustrates a diagram of an emission matrix of a hidden Markov model in accordance with one or more embodiments.

FIG. 9 illustrates a diagram of two transition matrices of hidden Markov models in accordance with one or more embodiments.

FIG. 10 illustrates a diagram of an example architecture of a neural network of the account interaction prediction system in accordance with one or more embodiments.

FIG. 11 illustrates a diagram of the account interaction prediction system in accordance with one or more embodiments.

FIG. 12 illustrates a flowchart of a series of acts for determining a predicted account interaction metric via a customized hidden Markov model in accordance with one or more embodiments.

FIG. 13 illustrates a block diagram of an example computing device for implementing one or more embodiments of the present disclosure.

### DETAILED DESCRIPTION

This disclosure describes one or more embodiments of an account interaction prediction system that manages user account interactions with computing applications utilizing individual-level hidden Markov models. In some embodiments, the account interaction prediction system utilizes user account data for a user account to generate a hidden Markov model. For example, the account interaction prediction system generates a customized hidden Markov model for the user account by utilizing user account data to generate an initial state matrix, a transition matrix, and/or an emission matrix for the hidden Markov model. In some implementations, the account interaction prediction system generates the matrices for the hidden Markov model utilizing one or more neural networks. For example, the account interaction prediction system generates the initial state matrix utilizing an initial state neural network, the transition matrix utilizing a transition neural network, and the emission matrix utilizing an emission neural network. Furthermore, in some embodiments, the account interaction prediction system utilizes the hidden Markov model with individualized matrices to determine one or more predicted account interaction metrics for the user account indicating predicted future interactions of the user account with one or more computing applications for one or more time periods.

As mentioned, in some implementations, the account interaction prediction system generates the matrices of the hidden Markov model utilizing neural networks. To illustrate, the account interaction prediction system utilizes neural networks trained to generate initial hidden state probability matrices, transition matrices, or emission matrices based on historical user activity data. Furthermore, the account interaction prediction system utilizes these matrices to predict hidden states and outcome states of the hidden Markov model. The account interaction prediction system customizes the hidden Markov models by generating matrices of individual hidden Markov models for individual user accounts.

Based on the predicted outcome states of the hidden Markov model, the account interaction prediction system determines one or more predicted account interaction metrics. For example, the account interaction prediction system predicts user account events, such as logins, access, permissions changes, website visits, purchases, and/or subscriptions to a computing application. In some implementations, the account interaction prediction system determines predicted account interaction metrics in connection with multiple computing applications (e.g., multiple access events). In some embodiments, the account interaction prediction system determines predicted account interaction metrics corresponding to different time periods (e.g., account purchases or subscriptions beginning at different times and/or ending at different times) or time scales.

To further illustrate, the account interaction prediction system generates the hidden Markov model matrices, which comprise probability values corresponding to hidden states (which are unobservable) and/or outcome states (which are observable) of the hidden Markov model. For instance, the account interaction prediction system generates a transition matrix comprising transition probability values indicating probabilities of moving from one given hidden state to another given hidden state. As another example, the account interaction prediction system generates an emission matrix comprising emission probability values indicating probabilities of moving from one given hidden state to one given outcome state. By customizing the matrices of a hidden Markov model according to user account data of a specific user account, the account prediction system determines hidden states, transitions, and outcome states based on the specific characteristics of the user account.

The account interaction prediction system provides a variety of technical advantages relative to conventional systems. For example, by utilizing trained neural networks to generate parameters of customized hidden Markov models, the account interaction prediction system increases flexibility relative to conventional systems. Specifically, the account interaction prediction system can generate multiple predictions of a variety of account interactions based on a limited amount of user account data. For example, the account interaction prediction system can generate predictions of user interactions for multiple time increments (e.g., month-by-month over a year), for lengthy time periods (e.g., several years), for differing time periods (e.g., for one year and for three years, simultaneously), and for numerous computing applications (e.g., individualized predictions for each of the numerous computing applications), all with the same limited user account dataset. In particular, the account interaction prediction system can generate these predictions based on a limited dataset comprising user account data having a short time period (e.g., only a few months of historical data) to correct for right censoring issues encountered by conventional systems. In this way, the account interaction prediction system additionally provides a novel computing feature of generating meaningful and accurate account interaction predictions having a time period longer than the duration of the input historical dataset. Furthermore, the account interaction prediction system can generate predictions of various account interactions with computing applications, such as an account beginning to actively access the computing application at one point in time, and ceasing to actively access the computing application at a later time.

Moreover, by generating the customized hidden Markov models utilizing deep neural networks, the account interaction prediction system enhances accuracy relative to conventional systems. For instance, in contrast to conventional systems that utilize a single model to generate predictions for a plurality of user accounts and/or computing applications, the account interaction prediction system generates a customized hidden Markov model for each user account to account for heterogeneity of various user accounts with unique attributes and/or combinations of attributes. The account interaction prediction system thus generates individual-level predictions that fully represent account interactions associated with numerous computing applications.

Furthermore, by generating customized hidden Markov models for individual user accounts, the account interaction prediction system improves efficiency with respect to conventional systems. For example, the hidden Markov models are not limited to a particular time scale, thereby allowing the account interaction prediction system to generate predictions for time periods longer than training dataset time periods. Thus, the account interaction prediction system can provide meaningful predictions with smaller input datasets, thereby alleviating computing resource needs, such as memory, storage space, and bandwidth. Additionally, in contrast to conventional systems that require training and use of separate models for each time period or time scale, the account interaction prediction system leverages a single model to generate predictions indicating account interactions with one or more computing applications over a variety of different time periods and/or time scales.

As illustrated by the foregoing discussion, the present disclosure utilizes a variety of terms to describe features and advantages of the account interaction prediction system. Additional detail is now provided regarding the meaning of such terms. For example, as used herein, the term “user account” refers to an account or profile associated with a user of one or more computing applications. In particular, the term “user account” includes a user profile with information relating to a subscriber of the one or more computing applications. While this disclosure discusses various examples of a user account in terms of an account management system that manages use of computing applications, the systems disclosed herein are not limited to this example and can apply to any computer system that manages user accounts for any purposes.

As used herein, the term “user account data” refers to data or information about a user account. In particular, the term “user account data” includes identification data, user account profile data (e.g., demographic data or other attributes of a user of the user account), user account activity data, and user device activity data. To illustrate, user account data includes identifying information about a user of a computing application. For instance, user account data includes a name, email address, social media handle, or other unique identifying number or identifying information. Moreover, user account data includes account activity data, such as login activity associated with one or more computing applications, visits to the one or more computing applications, access history of a user account, support ticket metadata associated with a user account, and access data associated with the one or more computing applications. For example, user account data includes account activity such as access times and durations, access permissions, metadata of content accessed, opened, created, viewed, copied, modified, saved, downloaded, sent, and/or closed by the user account. User account data also includes device activity data, such as information identifying a client device associated with the user account. For instance, user account data includes user device activity data associated with the one or more computing applications, such as device access times and durations, and metadata of content accessed, opened, created, viewed, copied, modified, saved, downloaded, sent, and/or closed by the client device. Furthermore, user account data includes historical account interactions with the one or more computing applications.

As used herein, the term “computing application” refers to an application or software tool provided to a computing device. In particular, the term “computing application” includes a desktop application, a mobile application, and/or a web-based application. To illustrate, a computing application includes an application for document creation and editing, creative content creation and editing, and/or image and video editing.

As used herein, the terms “account interaction” or “account action” refer to an action performed by a user account or by a client device associated with the user account. In particular, the terms “account interaction” or “account action” include events and/or actions associated with one or more computing applications. To illustrate, an account interaction or account action includes logins for the one or more computing applications, access events by the user account or the client device to the one or more computing applications, and/or subscription statuses of the user account to the one or more computing applications.

As used herein, the term “hidden Markov model” (or “HMM”) refers to a model representing a Markov process. In particular, the term “hidden Markov model” includes customized (e.g., individual) hidden Markov models for user accounts. To illustrate, a hidden Markov model includes a model containing hidden states and outcome states. As used herein, the term “hidden state” refers to an unobservable state of the model, and the term “outcome state” refers to an observable state of the model. In particular, a hidden state is influenced by a previous hidden state, and an outcome state is influenced by a hidden state. For example, a hidden state indicates hidden dynamics of user account interactions with computing applications, while an outcome state indicates observable user account interactions.

As used herein, the term “initial state matrix” (or “initial hidden state probability matrix”) refers to a matrix of initial state values for a hidden Markov model. The term “initial state value” (or “initial state probability value”) refers to a metric of a probability that a user account exists at or within one or more initial hidden states of the HMM.

As used herein, the term “transition matrix” (or “transition probability matrix”) refers to a matrix of transition values for a hidden Markov model. The term “transition value” (or “transition probability value”) refers to a metric of a probability that a user account will transition from one or more first hidden states of the HMM to one or more second hidden states of the HMM (or, alternatively, remain at the one or more first hidden states).

As used herein, the term “emission matrix” (or “emission probability matrix”) refers to a matrix of emission values for a hidden Markov model. The term “emission value” (or “emission probability value”) refers to a metric of a probability that a user account will emit one or more outcome states of the HMM based on having one or more hidden states of the HMM.

As used herein, the term “predicted account interaction metric” refers to a metric indicating a probability of a particular account interaction occurring for a user account. In particular, the term “predicted account interaction metric” includes predictions that the user account will interact with one or more computing applications or that a specific activity occurs in connection with the user account and the one or more computing applications. To illustrate, a predicted account interaction metric includes, but is not limited to, a login, an access event, a change in access permissions, and/or a subscription to the one or more computing applications.

As used herein, the term “machine-learning model” refers to a computer representation that is tunable (e.g., trained) based on inputs to approximate unknown functions used for generating corresponding outputs. In particular, a machine-learning model includes a computer-implemented model that utilizes algorithms to learn from, and make predictions on, known data by analyzing the known data to learn to generate outputs that reflect patterns and attributes of the known data. For instance, a machine learning model includes, but is not limited to, a neural network, a decision tree (e.g., a gradient boosted decision tree), association rule learning, inductive logic programming, support vector learning, Bayesian network, regression-based model (e.g., censored regression), principal component analysis, or a combination thereof.

As used herein, the term “neural network” refers to a class of tunable (e.g., trainable) machine-learning models that comprise interconnected artificial neurons (e.g., organized in layers) that communicate and learn to approximate complex functions and generate outputs. In particular, the term “neural network” includes an algorithm (or set of algorithms) that implements deep learning techniques (e.g., a deep neural network) to model high-level abstractions in data. For example, a neural network includes a convolutional neural network, a recurrent neural network (e.g., an LSTM), a graph neural network, or a generative adversarial neural network. To illustrate, a neural network includes a deep neural network that processes user account data to generate values and/or parameters of a hidden Markov model. In particular, a neural network extracts embeddings from the user account data to generate values of the HMM matrices.

As used herein, the term “feature” refers to a metric, value, characteristic, or property of a user account. For instance, in some cases, a feature includes a user account characteristic input into a neural network. As used herein, the term “embedding” refers to a metric, value, or vector generated by a neural network, and representing a feature of a user account. For example, in some cases, an embedding includes an output of a neural network based on user account data. To illustrate, the neural network is trained with historical user account data (e.g., in the form of user account features) to extract embeddings that represent the user account in the form of a model, such as the hidden Markov model.

As used herein, the term “time period” refers to temporal information about an account interaction, such as a predicted account interaction. In particular, the term “time period” includes a period of time and/or a time scale. To illustrate, a time period includes a start time, an end time, and/or a duration of an account interaction. For example, a time period includes a length of time of a subscription of a user account to one or more computing applications. As another example, a time period includes a starting time and ending time of the subscription of the user account to the one or more computing applications.

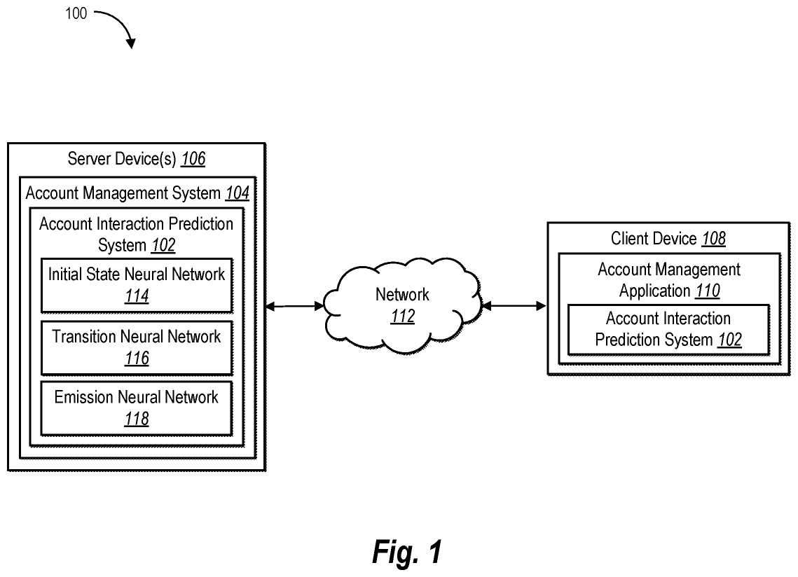

Additional detail will now be provided in relation to illustrative figures portraying example embodiments and implementations of an account interaction prediction system. For example, FIG. 1 illustrates a system 100 (or environment) in which an account interaction prediction system 102 operates in accordance with one or more embodiments. As illustrated, the system 100 includes server device(s) 106, a network 112, and a client device 108. As further illustrated, the server device(s) 106 and the client device 108 communicate with one another via the network 112.

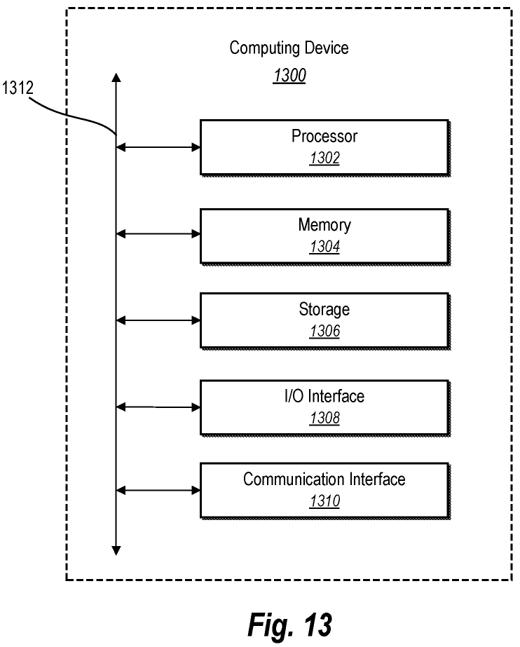

As shown in FIG. 1, the server device(s) 106 includes an account management system 104 that further includes the account interaction prediction system 102. In some embodiments, the account interaction prediction system 102 determines a predicted account interaction metric for a user account interacting with one or more computing applications. In some embodiments, the server device(s) 106 includes, but is not limited to, a computing device (such as explained below with reference to FIG. 13). In one or more embodiments, the account management system 104 utilizes data from the account interaction prediction system 102 (e.g., predicted account interaction metrics) to perform one or more operations to manage user accounts and/or hardware/software for a plurality of computing applications, such as by modifying availability of hardware resources for at least one computing application. Furthermore, in some embodiments, the account management system 104 provides customized messages/communications to user accounts (e.g., at corresponding client devices) based on the predicted account interaction metrics.

In some instances, the account interaction prediction system 102 receives a request (e.g., from the client device 108) to determine the predicted account interaction metric. For example, the request includes an identification of the user account and a query for current and predicted future interactions with the computing applications. To illustrate, the account interaction prediction system 102 generates one or more matrices of a hidden Markov model based on user account data for the user account, and determines the predicted account interaction metric based on the one or more matrices. Some embodiments of server device(s) 106 are operated by a user to perform a variety of functions via the account management system 104 on the server device(s) 106. For example, the server device(s) 106 (through the account interaction prediction system 102 on the account management system 104) performs functions such as, but not limited to, determining the user account data associated with the one or more computing applications for the user account, utilizing the user account data to generate one or more matrices of a customized hidden Markov model for the user account, and determining predicted account interaction metrics for the user account via the customized hidden Markov model.

In one or more embodiments, the server device(s) 106 utilizes one or more neural networks to generate one or more matrices for the customized hidden Markov model. For example, the server device(s) 106 utilizes an initial state neural network 114 to generate an initial state matrix, a transition neural network 116 to generate a transition matrix, and/or an emission neural network 118 to generate an emission matrix for the customized hidden Markov model. The server device(s) 106, in one or more embodiments, utilizes the hidden Markov model (e.g., including the one or more matrices) to determine a predicted account interaction metric for the user account according to one or more constraints or parameters (e.g., a time period).

Furthermore, as shown in FIG. 1, the system 100 includes the client device 108. In some embodiments, the client device 108 includes, but is not limited to, a mobile device (e.g., a smartphone, a tablet), a laptop computer, a desktop computer, a cloud-based computing service, or any other type of computing device, including those explained below with reference to FIG. 13. Some embodiments of the client device 108 are operated by a user to perform a variety of functions via an account management application 110 on the client device 108. For example, the client device 108 (through the account management application 110) performs functions such as, but not limited to, determining the user account data associated with the one or more computing applications for the user account, generating the one or more matrices of the customized hidden Markov model for the user account, or determining the predicted account interaction metric for the user account in connection with the one or more computing applications based on the one or more matrices.

To access the functionalities of the account interaction prediction system 102 (as described above and in greater detail below), in one or more embodiments, a user interacts with the account management application 110 on the client device 108. For example, the account management application 110 includes one or more software applications (e.g., to interact with user account data and/or determine predicted account interaction metrics in accordance with one or more embodiments described herein) installed on the client device 108, such as an account interaction prediction application. In certain instances, the account management application 110 is hosted on the server device(s) 106. Additionally, when hosted on the server device(s) 106, the account management application 110 is accessed by the client device 108 through a web browser and/or another online interfacing platform and/or tool.

As illustrated in FIG. 1, in some embodiments, the account interaction prediction system 102 is hosted by the account management application 110 on the client device 108 (e.g., additionally or alternatively to being hosted by the account management system 104 on the server device(s) 106). For example, the account interaction prediction system 102 performs the interaction prediction techniques described herein on the client device 108. In some implementations, the account interaction prediction system 102 utilizes the server device(s) 106 to implement or apply machine-learning models, such as the initial state neural network 114, the transition neural network 116, and the emission neural network 118. In one or more embodiments, the account interaction prediction system 102 utilizes the client device 108 to implement or apply machine-learning models, such as the initial state neural network 114, the transition neural network 116, and the emission neural network 118.

Further, although FIG. 1 illustrates the account interaction prediction system 102 being implemented by a particular component and/or device within the system 100 (e.g., the server device(s) 106 and/or the client device 108), in some embodiments the account interaction prediction system 102 is implemented, in whole or in part, by other computing devices and/or components in the system 100. For instance, in some embodiments, the account interaction prediction system 102 is implemented on another client device. More specifically, in one or more embodiments, the description of (and acts performed by) the account interaction prediction system 102 are implemented by (or performed by) the account management application 110 on another client device.

In some embodiments, the account management application 110 includes a web hosting application that allows the client device 108 to interact with content and services hosted on the server device(s) 106. To illustrate, in one or more implementations, the client device 108 accesses a web page or computing application supported by the server device(s) 106. The client device 108 provides input to the server device(s) 106 (e.g., an identification of one or more user accounts and a query for current and/or predicted future interactions by the one or more user accounts with the one or more computing applications). In response, the account interaction prediction system 102 on the server device(s) 106 performs operations described herein to determine one or more predicted account interaction metrics for the one or more user accounts. The server device(s) 106 provides the output or results of the operations (e.g., the one or more predicted account interaction metrics) to the client device 108. As another example, in some implementations, the account interaction prediction system 102 on the client device 108 performs operations described herein to determine the one or more predicted account interaction metrics. The client device 108 provides the output or results of the operations (e.g., the one or more predicted account interaction metrics) via a display of the client device 108, and/or transmits the output or results of the operations to another device (e.g., the server device(s) 106 and/or another client device). In some embodiments, the account interaction prediction system 102 utilizes batch scoring to perform the operations described herein. In some implementations, the account interaction prediction system 102 utilizes real-time scoring to perform the operations described herein.

Additionally, as shown in FIG. 1, the system 100 includes the network 112. As mentioned above, in some instances, the network 112 enables communication between components of the system 100. In certain embodiments, the network 112 includes a suitable network and may communicate using any communication platforms and technologies suitable for transporting data and/or communication signals, examples of which are described with reference to FIG. 13. Furthermore, although FIG. 1 illustrates the server device(s) 106 and the client device 108 communicating via the network 112, in certain embodiments, the various components of the system 100 communicate and/or interact via other methods (e.g., the server device(s) 106 and the client device 108 communicate directly).

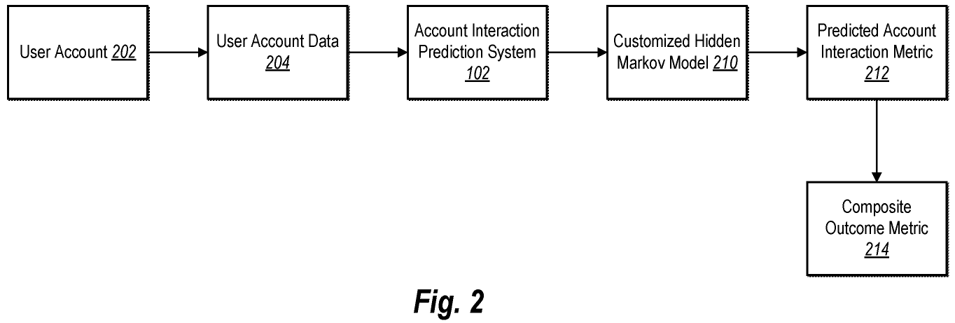

As discussed above, in some embodiments, the account interaction prediction system 102 determines one or more predicted account interaction metrics. For instance, FIG. 2 illustrates the account interaction prediction system 102 determining a predicted account interaction metric 212 in accordance with one or more embodiments. Specifically, FIG. 2 shows the account interaction prediction system 102 identifying a user account 202, determining user account data 204 for the user account 202, generating a customized hidden Markov model 210 based on the user account data 204, determining the predicted account interaction metric 212 utilizing the customized hidden Markov model 210, and generating a composite outcome metric 214 based on the predicted account interaction metric 212.

As mentioned, in some implementations, the account interaction prediction system 102 identifies the user account 202. For instance, the account interaction prediction system 102 receives an indication of the user account 202 (e.g., from a client device), along with a request for the predicted account interaction metric 212 and/or the composite outcome metric 214 for the user account 202.

In some embodiments, the account interaction prediction system 102 determines the user account data 204 for the user account 202. For example, the account interaction prediction system 102 retrieves account profile data, account activity data, and/or device activity data for the user account 202 that indicates, among other things, past interactions with one or more computing applications. As explained in additional detail below, the account interaction prediction system 102 utilizes the user account data 204 to generate parameters of the customized hidden Markov model 210 that are specific to the user account 202.

As just mentioned, in some implementations, the account interaction prediction system 102 generates the customized hidden Markov model 210 based on the user account data 204. For example, the account interaction prediction system 102 generates probability values (e.g., initial state values, transition values, and emission values, as described below) for the customized hidden Markov model 210 associated with the user account 202.

As discussed, in some implementations, the account interaction prediction system 102 determines the predicted account interaction metric 212 utilizing the customized hidden Markov model 210. For instance, as described further below, the account interaction prediction system 102 samples outcome states of the customized hidden Markov model 210 to generate the predicted account interaction metric 212.

In one or more embodiments, the account interaction prediction system 102 utilizes the customized hidden Markov model 210 to generate one or more predicted metrics indicating an estimated lifecycle of interactions of the user account for one or more computing applications. For example, the account interaction prediction system 102 generates the predicted account interaction metric 212 to indicate an estimated state (e.g., conversion and/or churn of a subscription or account access, purchase of a product SKU or service) of the user account with respect to the one or more computing applications.

In some embodiments, the account interaction prediction system 102 utilizes the predicted account interaction metric 212 to generate the composite outcome metric 214. For instance, the account interaction prediction system 102 determines a lifetime value of the user account 202 in terms of conversion and/or churn of one or more subscriptions, purchases, or account accesses to one or more computing applications. To illustrate, the account interaction prediction system 102 utilizes the estimated state of the user account to determine whether the user account has a first set of access permissions (e.g., a set of access permissions associated with an unpaid account), a second set of access permissions (e.g., a set of access permissions associated with a paid account), or other set of access permissions (e.g., one of a plurality of tiers of access permissions) for a computing application. In some embodiments, the account interaction prediction system 102 also determines the estimated lifecycle of interactions in connection with generating electronic messages to provide to a client device of the user account for one or more computing applications.

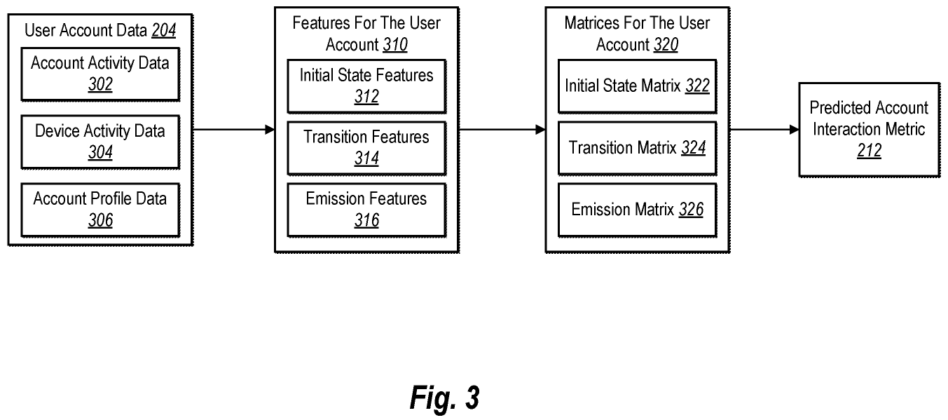

As discussed above, in some embodiments, the account interaction prediction system 102 generates a customized hidden Markov model for a user account. For instance, FIG. 3 illustrates the account interaction prediction system 102 generating matrices for the customized hidden Markov model in accordance with one or more embodiments. Specifically, FIG. 3 shows the account interaction prediction system 102 determining user account data for a user account (e.g., the user account data 204 for the user account 202 of FIG. 2), generating features 310 for the user account 202, generating matrices 320 for the user account 202, and generating the predicted account interaction metric 212.

To illustrate, the account interaction prediction system 102 obtains the user account data 204 including account activity data 302, device activity data 304, and/or account profile data 306. For instance, the account interaction prediction system 102 detects the account activity data 302, which indicates actions of the user account in relation to the one or more computing applications. For example, in response to determining that the user account has opened and used a first computing application, the account interaction prediction system 102 discerns such activity by the user account in the account activity data 302. As another example, in response to determining that the user account has previously subscribed (e.g., requested access permissions), but is no longer subscribing, to a second computing application, the account interaction prediction system 102 notes the subscription history associated with the second computing application.

Additionally, in some cases, the account interaction prediction system 102 detects the device activity data 304, which indicates actions of a user device (such as a client device) associated with the user account 202, in relation to the one or more computing applications. For example, the account interaction prediction system 102 detects device activity associated with the user account 202 in response to determining that a client device logged in to the user account 202. In additional embodiments, the account interaction prediction system 102 detects device activity in response to the client device opening and using the first computing application. Furthermore, the account interaction prediction system 102 also determines whether more than one client device associated with the user account 202 has accessed the first computing application.

Furthermore, in some embodiments, the account interaction prediction system 102 detects the account profile data 306, which indicates identifying information, demographic characteristics, and/or static attributes for the user account 202. For instance, in some implementations, the account interaction prediction system 102 determines a user account number, a user account setup date, a user account address, a user account email address, and/or a user account social media handle. Moreover, in some embodiments, the account interaction prediction system 102 determines demographic data associated with the user account 202, such as an age, gender, country, educational status, and/or geographic location of a user of the user account 202.

As mentioned, in some implementations, the account interaction prediction system 102 generates features 310 for the user account 202 based on the user account data 204. To illustrate, the account interaction prediction system 102 generates initial state features 312, transition features 314, and/or emission features 316. For instance, the account interaction prediction system 102 analyzes the account activity data 302, the device activity data 304, and/or the account profile data 306 to determine characteristics of the user account 202 and convert the characteristics into the features 310. To illustrate, the account interaction prediction system 102 converts the account activity data 302, the device activity data 304, and/or the account profile data 306 into numerical representations user account characteristics for processing (e.g., through one or more neural networks, as described further below).

In particular, the account interaction prediction system 102 generates initial state features 312 that represent characteristics of the user account 202 associated with likelihoods that the user account has one or more particular initial hidden states. Additionally, the account interaction prediction system 102 generates transition features 314 that represent characteristics of the user account 202 associated with likelihoods that the user account will move from one or more particular hidden states to one or more different particular hidden states. Furthermore, the account interaction prediction system 102 generates emission features 316 that represent characteristics of the user account 202 associated with likelihoods that the user account will emit one or more particular outcome states based on having one or more hidden states.

Based on the features 310 for the user account 202, in some implementations, the account interaction prediction system 102 generates the matrices 320. To illustrate, the account interaction prediction system 102 generates an initial state matrix 322, a transition matrix 324, and an emission matrix 326. For example, the account interaction prediction system 102 generates the initial state matrix 322 by generating elements of the initial state matrix 322 (e.g., initial state values) from the initial state features 312. Similarly, in some cases, the account interaction prediction system 102 generates the transition matrix 324 by generating elements of the transition matrix 324 (e.g., transition values) from the transition features 314. Additionally, in some embodiments, the account interaction prediction system 102 generates the emission matrix 326 by generating elements of the emission matrix 326 (e.g., emission values) from the emission features 316.

To illustrate, in some implementations, the account interaction prediction system 102 generates initial state probability values from the initial state features 312, indicating likelihoods that the user account 202 has an initial state of the customized hidden Markov model. The account interaction prediction system 102 populates the initial state matrix 322 from the initial state probability values. Similarly, in some implementations, the account interaction prediction system 102 generates transition probability values from the transition features 314, indicating likelihoods that the user account 202 will transition from one hidden state to another hidden state of the customized hidden Markov model. The account interaction prediction system 102 populates the transition matrix 324 from the transition probability values. Additionally, in some implementations, the account interaction prediction system 102 generates emission probability values from the emission features 316, indicating likelihoods that the user account 202 emits an outcome state from a hidden state of the customized hidden Markov model. The account interaction prediction system 102 populates the emission matrix 326 from the emission probability values.

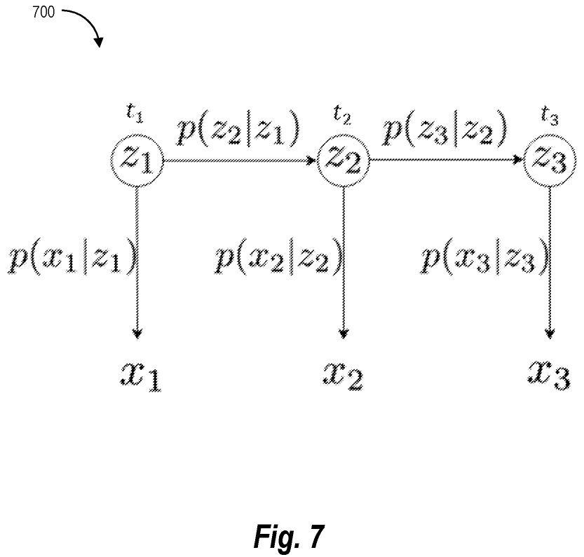

As mentioned above, in some implementations, the account interaction prediction system 102 utilizes the customized hidden Markov model 210 to generate the predicted account interaction metric 212. In particular, in some embodiments, the account interaction prediction system 102 utilizes the matrices 320 to generate the predicted account interaction metric 212. For example, the account interaction prediction system 102 utilizes the initial state matrix 322, the transition matrix 324, and the emission matrix 326 to generate a vector of predicted outcome states for the user account at one or more discrete points in time. As described further below in connection with FIG. 7, in some implementations, the account interaction prediction system 102 samples probabilities of user account reaching the various hidden states and outcome states based on the probability values in the matrices 320.

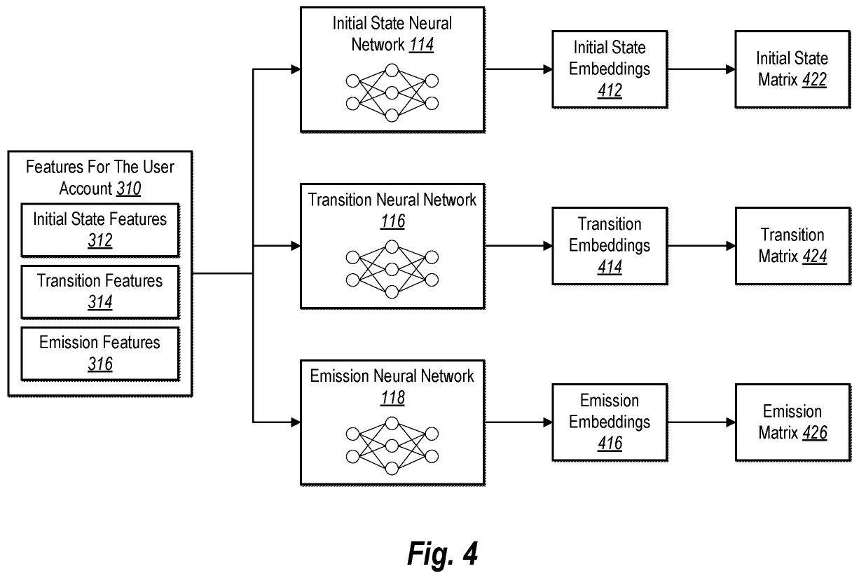

As mentioned, in some embodiments, the account interaction prediction system 102 generates the matrices of the customized hidden Markov model utilizing one or more neural networks. For instance, FIG. 4 illustrates the account interaction prediction system 102 generating matrices of the customized hidden Markov model in accordance with one or more embodiments. Specifically, FIG. 4 shows the account interaction prediction system 102 processing the features 310 for the user account through an initial state neural network 114, a transition neural network 116, and an emission neural network 118 to generate embedding and matrices for the user account.

To illustrate, in some embodiments, the account interaction prediction system 102 processes the features 310 through the initial state neural network 114 to generate initial state embeddings 412 and an initial state matrix 422. In some embodiments, the account interaction prediction system 102 generates the initial state embeddings 412 by processing the initial state features 312 through the initial state neural network 114. For example, the account interaction prediction system 102 utilizes the initial state neural network 114 to convert the initial state features 312 into a latent vector space that represents probability values of the user account taking on one or more hidden states. For instance, the account interaction prediction system 102 utilizes the initial state neural network 114 to determine patterns in the initial state features 312 that resemble patterns from training data, and to generate the initial state embeddings 412 as outputs according to the training of the initial state neural network 114.

Moreover, in some implementations, the account interaction prediction system 102 generates the initial state matrix 422 by utilizing the initial state neural network 114 to generate a plurality of initial state values from the initial state embeddings 412. For instance, the account interaction prediction system 102 generates initial state values and populates the initial state matrix 422 with the initial state values. In some embodiments, the initial state matrix 422 is the same as or similar to the initial state matrix 322 described above.

Furthermore, in some embodiments, the account interaction prediction system 102 processes the features 310 through the transition neural network 116 to generate transition embeddings 414 and a transition matrix 424. In some embodiments, the account interaction prediction system 102 generates the transition embeddings 414 by processing the transition features 314 through the transition neural network 116. For example, the account interaction prediction system 102 utilizes the transition neural network 116 to convert the transition features 314 into a latent vector space that represents probability values of the user account transitioning from one or more hidden states to one or more other hidden states. For instance, the account interaction prediction system 102 utilizes the transition neural network 116 to determine patterns in the transition features 314 that resemble patterns from training data, and to generate the transition embeddings 414 as outputs according to the training of the transition neural network 116.

Moreover, in some implementations, the account interaction prediction system 102 generates the transition matrix 424 by utilizing the transition neural network 116 to generate a plurality of transition values from the transition embeddings 414. For instance, the account interaction prediction system 102 generates transition values and populates the transition matrix 424 with the transition values. In some embodiments, the transition matrix 424 is the same as or similar to the transition matrix 324 described above.

Additionally, in some embodiments, the account interaction prediction system 102 processes the features 310 through the emission neural network 118 to generate emission embeddings 416 and an emission matrix 426. In some embodiments, the account interaction prediction system 102 generates the emission embeddings 416 by processing the emission features 316 through the emission neural network 118. For example, the account interaction prediction system 102 utilizes the emission neural network 118 to convert the emission features 316 into a latent vector space that represents probability values of the user account emitting one or more outcome states from one or more hidden states. For instance, the account interaction prediction system 102 utilizes the emission neural network 118 to determine patterns in the emission features 316 that resemble patterns from training data, and to generate the emission embeddings 416 as outputs according to the training of the emission neural network 118.

Furthermore, in some implementations, the account interaction prediction system 102 generates the emission matrix 426 by utilizing the emission neural network 118 to generate a plurality of emission values from the emission embeddings 416. For instance, the account interaction prediction system 102 generates emission values and populates the emission matrix 426 with the emission values. In some embodiments, the emission matrix 426 is the same as or similar to the emission matrix 326 described above.

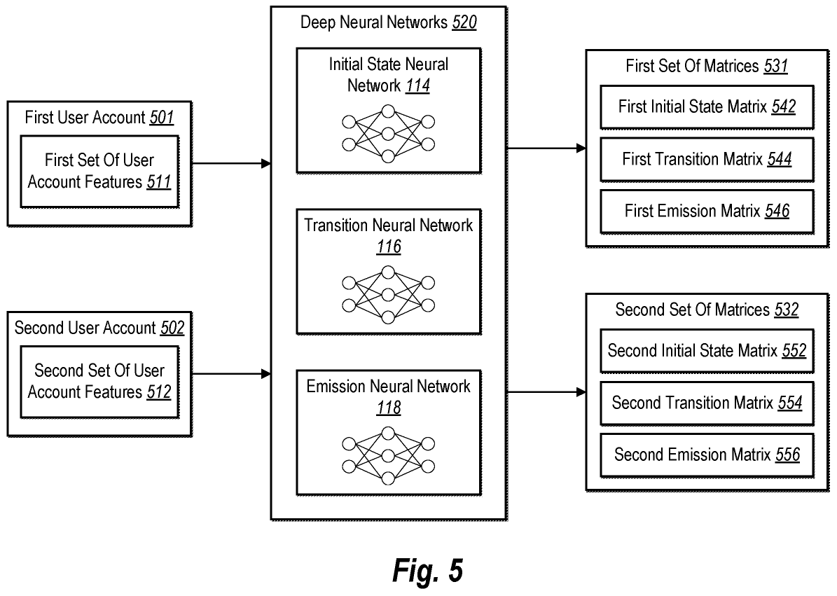

As mentioned, in some embodiments, the account interaction prediction system 102 generates a plurality of individualized hidden Markov models for a plurality of user accounts. For instance, FIG. 5 illustrates the account interaction prediction system 102 generating customized matrices of a first HMM for a first user account, and customized matrices of a second HMM for a second user account, in accordance with one or more embodiments. Specifically, FIG. 5 shows the account interaction prediction system 102 identifying a first user account 501, determining a first set of user account features 511 for the first user account 501, processing the first set of user account features 511 through one or more deep neural networks 520, and generating a first set of matrices 531 for the first user account 501. Additionally, FIG. 5 shows the account interaction prediction system 102 identifying a second user account 502, determining a second set of user account features 512 for the second user account 502, processing the second set of user account features 512 through the one or more deep neural networks 520, and generating a second set of matrices 532 for the second user account 502. In some embodiments, the first set of user account features 511 and the second set of user account features 512 resemble the features 310 described above.

To illustrate, in some implementations, the account interaction prediction system 102 processes the first set of user account features 511 through the deep neural networks 520 (e.g., the initial state neural network 114, the transition neural network 116, and the emission neural network 118) as described above for the features 310. By processing the first set of user account features 511 through the deep neural networks 520, the account interaction prediction system 102 generates a first initial state matrix 542, a first transition matrix 544, and a first emission matrix 546. In this way, the account interaction prediction system 102 generates a customized hidden Markov model for the first user account 501, comprising the first initial state matrix 542, the first transition matrix 544, and the first emission matrix 546. For instance, the first initial state matrix 542, the first transition matrix 544, and the first emission matrix 546 comprise, respectively, a first plurality of initial state values, a first plurality of transition values, and a first plurality of emission values.

In some embodiments, the account interaction prediction system 102 processes the second set of user account features 512 through the deep neural networks 520 (e.g., the initial state neural network 114, the transition neural network 116, and the emission neural network 118) as described above for the features 310. By processing the second set of user account features 512 through the deep neural networks 520, the account interaction prediction system 102 generates a second initial state matrix 552, a second transition matrix 554, and a second emission matrix 556. In this way, the account interaction prediction system 102 generates a customized hidden Markov model for the second user account 502, comprising the second initial state matrix 552, the second transition matrix 554, and the second emission matrix 556. For instance, the second initial state matrix 552, the second transition matrix 554, and the second emission matrix 556 comprise, respectively, a second plurality of initial state values, a second plurality of transition values, and a second plurality of emission values.

As illustrated in FIG. 5, the account interaction prediction system 102 generates separate matrices for separate hidden Markov models corresponding to different user accounts. In particular, the account interaction prediction system 102 utilizes the deep neural networks 520 to extract separate features corresponding to the first user account 501 and the second user account 502 to generate the first set of matrices 531 and the second set of matrices 532, respectively. Accordingly, the account interaction prediction system 102 generates hidden Markov models unique to the separate user accounts by taking into consideration the characteristics of the corresponding user accounts.

Alternatively, in some implementations, the account interaction prediction system 102 uses separate neural networks to generate the sets of matrices for a plurality of user accounts. To illustrate, in some embodiments, the account interaction prediction system 102 utilizes a first initial state neural network, a first transition neural network, and a first emission neural network to generate the HMM matrices for a first user account. Additionally, in some embodiments, the account interaction prediction system 102 utilizes a second initial state neural network, a second transition neural network, and a second emission neural network to generate the HMM matrices for a second user account. For example, the account interaction prediction system 102 trains the first set of neural networks using a first dataset (e.g., a first dataset comprising user account features of a first segment of user accounts that includes user account features for the first user account), and trains the second set of neural networks using a second dataset (e.g., a second dataset comprising user account features of a second segment (different from the first segment) of user accounts that includes user account features for the second user account).

In some embodiments, the account interaction prediction system 102 generates a customized hidden Markov model for a group of user accounts sharing similar features. For instance, the account interaction prediction system 102 generates a set of matrices customized to a plurality of user accounts that share a characteristic (e.g., a group of user accounts having the same account actions in relation to a computing application).

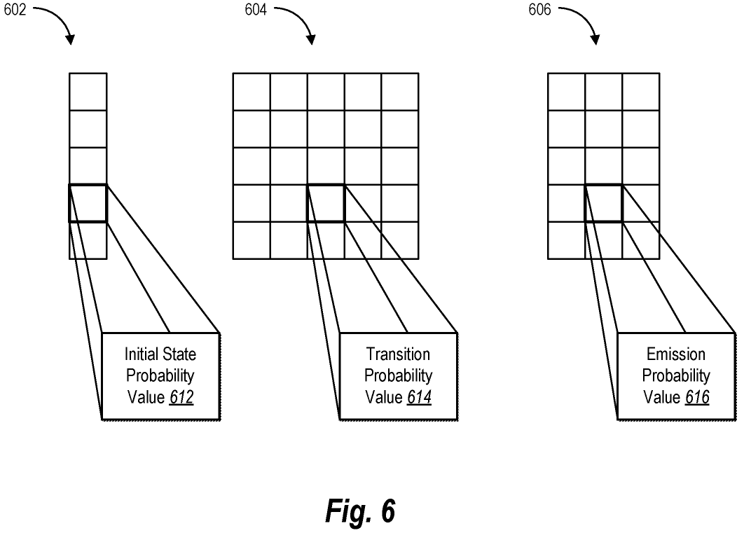

As mentioned, in some implementations, the account interaction prediction system 102 generates probability values to populate the HMM matrices. For instance, FIG. 6 illustrates the account interaction prediction system 102 populating the HMM matrices with probability values in accordance with one or more embodiments. Specifically, FIG. 6 shows an initial state matrix 602, a transition matrix 604, and an emission matrix 606.

In particular, FIG. 6 shows an element of the initial state matrix 602 comprising an initial state probability value 612. In some cases, the initial state probability value 612 corresponds to one or more hidden states of a hidden Markov model for a user account. To illustrate, the initial state probability value 612 indicates a likelihood that the user account has assumed a particular initial hidden state of the hidden Markov model. For instance, the initial state probability value 612 indicates the probability of the user account corresponding to the particular initial hidden state based on the past interactions of the user account with respect to one or more computing applications. The initial state matrix 602 comprises a plurality of initial state values corresponding to a plurality of hidden states of the hidden Markov model for the user account.

Relatedly, FIG. 6 shows an element of the transition matrix 604 comprising a transition probability value 614. In some cases, the transition probability value 614 corresponds to one or more hidden states of the hidden Markov model for the user account. To illustrate, the transition probability value 614 indicates a likelihood that the user account will transition from a first hidden state of the hidden Markov model to a second hidden state of the hidden Markov model, or alternatively, the likelihood that the user account will remain at the first hidden state. The transition matrix 604 comprises a plurality of transition values corresponding to a plurality of hidden states of the hidden Markov model for the user account.

Additionally, FIG. 6 shows an element of the emission matrix 606 comprising an emission probability value 616. In some cases, the emission probability value 616 corresponds to one or more hidden states of the hidden Markov model for the user account. To illustrate, the emission probability value 616 indicates a likelihood that the user account will emit an output state from a hidden state of the hidden Markov model. The emission matrix 606 comprises a plurality of emission values corresponding to a plurality of hidden states of the hidden Markov model for the user account.

To further illustrate, in some embodiments, the account interaction prediction system 102 determines a number nₛ of hidden states (e.g., based on assumptions of characteristics of the user account) and a number nₒ of outcome states (e.g., based on observations of user account data of the user account) for the hidden Markov model. For instance, the account interaction prediction system 102 generates an initial state matrix π (e.g., the initial state matrix 602) having a dimension nₛ×1. The account interaction prediction system 102 populates the initial state matrix π with initial state probability values (e.g., including the initial state probability value 612). For example, the account interaction prediction system 102 assigns an element π₁ of the initial state matrix π with a probability of assuming a first hidden state: π₁=P(xₜ=z₁). Additionally, the account interaction prediction system 102 generates a transition matrix Q (e.g., the transition matrix 604) having a dimension nₛ×nₛ. The account interaction prediction system 102 populates the transition matrix Q with transition probability values (e.g., including the transition probability value 614). For example, the account interaction prediction system 102 assigns an element q₂₁ of the transition matrix Q with a probability of transitioning from a first hidden state to a second hidden state: q₂₁=P(zₜ₊₁=z₂|zₜ=z₁). Furthermore, the account interaction prediction system 102 generates an emission matrix M (e.g., the emission matrix 606) having dimension nₛ×nₒ. The account interaction prediction system 102 populates the emission matrix M with emission probability values (e.g., including the emission probability value 616). For example, the account interaction prediction system 102 assigns an element m₁₁ of the emission matrix M with a probability of emitting a first outcome state from a first hidden state: m₁₁=P(xₜ=x₁|zₜ=z₁).

As described, in some implementations, the account interaction prediction system 102 generates individual-level parameters of the hidden Markov model. For example, the account interaction prediction system 102 utilizes individualized characteristics of a user account to generate the probability values. To illustrate, the account interaction prediction system 102 generates the xth element of the initial state matrix according to πₓ=f(θ(i)) where θ(i) is an individual-level characteristic of the user account, and where f is a function for the initial state probability values. For example, the account interaction prediction system 102 determines the function f utilizing the initial state neural network 114. To further illustrate, the account interaction prediction system 102 generates the xyth element of the transition matrix according to q_{xy}=g(θ(i)) where g is a function for the transition probability values. For instance, the account interaction prediction system 102 determines the function g utilizing the transition neural network 116. To further illustrate, the account interaction prediction system 102 generates the xyth element of the emission matrix according to m_{xy}=h(θ(i)) where h is a function for the emission probability values. For example, the account interaction prediction system 102 determines the function h utilizing the emission neural network 118.

As discussed above, in some embodiments, the account interaction prediction system 102 utilizes one or more hidden Markov models to determine one or more predicted account interaction metrics. For instance, FIG. 7 illustrates the account interaction prediction system 102 utilizing a hidden Markov model in accordance with one or more embodiments. Specifically, FIG. 7 shows a diagram of a hidden Markov model 700 comprising hidden states z₁, z₂, and z₃, at times t₁, t₂, and t₃, respectively. Additionally, the hidden Markov model 700 comprises outcome states x₁, x₂, and x₃, at times t₁, t₂, and t₃, respectively.

To further illustrate the hidden Markov model 700, FIG. 7 shows probability values associated with the various hidden states and outcome states. In particular, a transition probability value p(z₂|z₁) represents the likelihood that a user account will transition from the hidden state z₁ to the hidden state z₂. Similarly, a transition probability value p(z₃|z₂) represents the likelihood that the user account will transition from the hidden state z₂ to the hidden state z₃. Relatedly, an emission probability value p(x₁|z₁) represents the likelihood that the user account will emit the outcome x₁ from the hidden state z₁. Similarly, an emission probability value p(x₂|z₂) represents the likelihood that the user account will emit the outcome x₂ from the hidden state z₂, and an emission probability value p(x₃|z₃) represents the likelihood that the user account will emit the outcome x₃ from the hidden state z₃. To illustrate, the transition probability values p(z₂|z₁) and p(z₃|z₂) are representative of the transition probability value 614 described above. Relatedly, the emission probability values p(x₁|z₁), p(x₂|z₂), and p(x₃|z₃) are representative of the emission probability value 616 described above.

As explained, the account interaction prediction system 102 utilizes the hidden Markov model to generate predicted account interaction metrics by determining likelihoods of outcome states of the hidden Markov model. To illustrate, the account interaction prediction system 102 determines an outcome state of the hidden Markov model based on a hidden state of the plurality of hidden states for the user account. Specifically, the account interaction prediction system 102 determines the plurality of transition probability values (e.g., a plurality of transition values of a transition matrix) and the plurality of emission probability values (e.g., a plurality of emission values of an emission matrix) of the hidden Markov model. According to the plurality of transition probability values and the plurality of emission probability values, the account interaction prediction system 102 determines the outcome state of the hidden Markov model, and consequently determines the predicted account interaction metric for the user account.

To further illustrate, in some embodiments, the account interaction prediction system 102 samples hidden states and outcome states of the hidden Markov model based on the probability values associated with the hidden Markov model (e.g., the initial state probability values, the transition probability values, and the emission probability values). For example, the account interaction prediction system 102 utilizes stochastic methods to propagate states of the hidden Markov model, beginning with an initial hidden state (e.g., based on the initial state probability values), and proceeding through one or more various hidden states (e.g., based on the transition probability values) to an outcome state (e.g., based on the emission probability values). In some implementations, the account interaction prediction system 102 determines times associates with the hidden states and the outcome states sampled. For instance, the account interaction prediction system 102 determines a first time at which the user account reaches a first outcome state, and a second time at which the user account reaches a second outcome state.

Based on the first time and the second time, the account interaction prediction system 102 determines a time period for a predicted account interaction metric. For example, the account interaction prediction system 102 determines a difference between the second time and the first time to determine a duration for the predicted account interaction metric.

As noted, the account interaction prediction system 102, in some embodiments, determines multiple predicted account interaction metrics. In some cases, the multiple predicted account interaction metrics are associated with multiple user accounts. For instance, the account interaction prediction system 102 determines a first predicted account interaction metric for a first user account (e.g., based on the first set of matrices 531) and a second predicted account interaction metric for a second user account (e.g., based on the second set of matrices 532).

In some other cases, the multiple predicted account interaction metrics are for the same user account. For example, the account interaction prediction system 102 determines a first predicted account interaction metric for a user account and a second predicted account interaction metric for the user account. To illustrate, the account interaction prediction system 102 utilizes the same customized hidden Markov model to generate both predicted account interaction metrics. For instance, the account interaction prediction system 102 determines the first predicted account interaction metric corresponding to a first time period, and determines the second predicted account interaction metric corresponding to a second time period (e.g., different from the first time period). For example, in some cases, the first predicted account interaction metric and the second predicted account interaction metric have different time durations (e.g., the first predicted account interaction metric corresponds with a three-month duration, whereas the second predicted account interaction metric corresponds with a one-year duration). As another example, in some cases, the predicted account interaction metrics have the same time duration, but different starting times (e.g., the first predicted account interaction metric corresponds with a one-year duration beginning on January 1, whereas the second predicted account interaction metric has a one-year duration beginning on July 1).

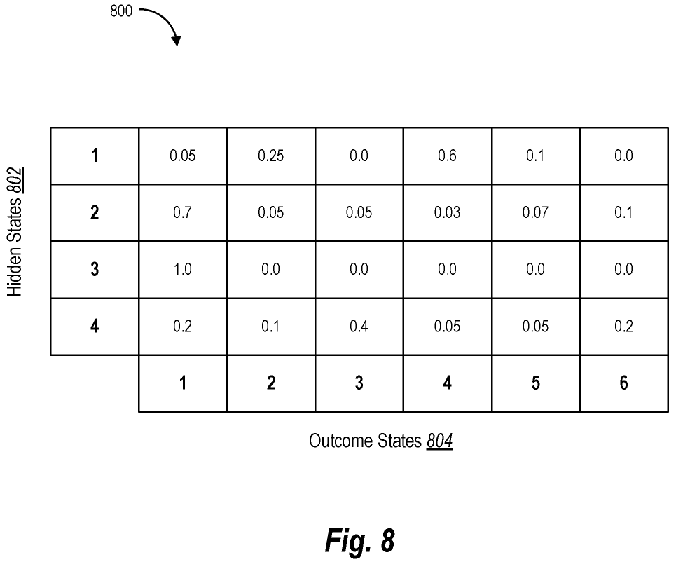

As discussed above, in some embodiments, the account interaction prediction system 102 generates emission matrices. For instance, FIG. 8 illustrates the account interaction prediction system 102 generating an emission matrix in accordance with one or more embodiments. Specifically, FIG. 8 shows an emission matrix 800 comprising a plurality of emission values. As illustrated, the plurality of emission values corresponds with a plurality of hidden states 802 and with a plurality of outcome states 804.

In some embodiments, the account interaction prediction system 102 utilizes the emission matrix 800 to determine an outcome state of the hidden Markov model based on a hidden state of the hidden Markov model. As an example, as shown in FIG. 8, if a user account is currently at hidden state 2 of the hidden states 802, the user account has a 0.7 chance of emitting outcome state 2 of the outcome states 804.

In some implementations, the outcome states 804 represent account interactions with one or more computing applications. For instance, the outcome states 804 represent subscription statuses of a user account for the one or more computing applications. In some embodiments, the account interaction prediction system 102 determines a computing application of the one or more computing applications indicated by the predicted account interaction metric. For instance, the outcome states (and, relatedly, the predicted account interaction metric) indicate a subset of the one or more computing applications that receive an account interaction from the user account. The account interaction prediction system 102 evaluates the predicted account interaction metric to determine the computing application (or computing applications) of the one or more computing applications with which the user account is likely to interact.

As an example, a given outcome state indicates a probability of the user account having an active subscription (or activating a subscription) for a specific computing application based on a current hidden state corresponding to the features of the user account. In one or more embodiments, transitioning from one hidden state to another hidden state indicates a change in the likelihood of the user account having an active subscription for the computing application. In additional embodiments, transitioning from one hidden state to another hidden state indicates a new subscription preference for the user account in connection with a separate computing application (e.g., a related computing application in a suite of computing applications). Thus, the account interaction prediction system 102 utilizes a customized hidden Markov model to determine specific likelihoods of future interactions with one or more computing applications according to account activity and/or device activity of the user account associated with the one or more computing applications. Furthermore, in some embodiments, the account interaction prediction system 102 utilizes the predicted metrics to generate additional metrics, such as by converting the predicted metrics to estimated conversion rates, estimated churn rates, total lifetime value metrics, or other metrics associated with interactions by user accounts with one or more computing applications.

Additionally, in some implementations, the account interaction prediction system 102 generates a message for display at a client device associated with the user account identifying the computing application (or computing applications) with which the user account is likely to interact. For example, the account interaction prediction system 102 generates the message, which comprises an indication of a user account action associated with the computing application (e.g., a predicted future account interaction with the computing application). In one or more embodiments, the account interaction prediction system 102 generates a message indicating one or more computing applications with which the user account has interacted previously and with which the user account is likely to interact according to a predicted account interaction metric. To illustrate, the account interaction prediction system 102 determines an estimated time period in which the user account is likely to activate a subscription for a computing application and generates a message to include a selectable option to subscribe to the computing application at the estimated time period. In some embodiments, the account interaction prediction system 102 generates and provides the message to a client device of a user account (e.g., automatically and without user interactions) in response to detecting a trigger (e.g., a predicted account interaction metric above or below a certain threshold value).

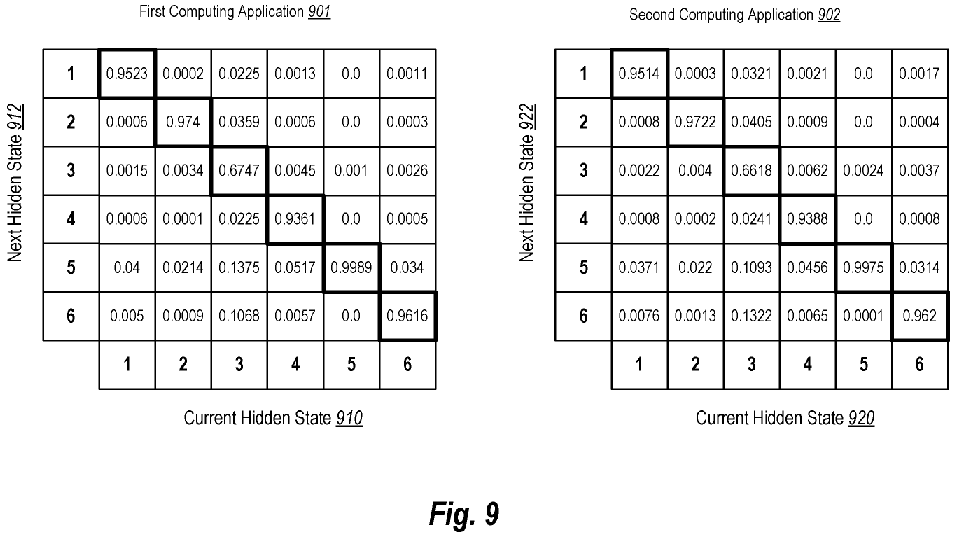

As discussed above, in some embodiments, the account interaction prediction system 102 generates transition matrices. For instance, FIG. 9 illustrates the account interaction prediction system 102 generating two transition matrices in accordance with one or more embodiments. Specifically, FIG. 9 shows a transition matrix for a user account with respect to a first computing application 901 and a second transition matrix for the user account with respect to a second computing application 902, each comprising a plurality of transition values. As illustrated, the plurality of transition values of the transition matrix for the first computing application 901 corresponds with a plurality of current hidden states 910 and a plurality of next hidden states 912. Moreover, the plurality of transition values of the transition matrix for the second computing application 902 corresponds with a plurality of current hidden states 920 and a plurality of next hidden states 922.

In some embodiments, the account interaction prediction system 102 utilizes a transition matrix to determine a next hidden state of a hidden Markov model based on a current hidden state of the hidden Markov model. As illustrated by FIG. 9, the account interaction prediction system 102, in some implementations, customizes the HMM matrices not only based on the user account, but also based on the computing application of the one or more computing applications. As an example, as shown in the transition matrix for the first computing application 901, if a user account associated with the first computing application is currently at hidden state 2 of the current hidden states 910, the user account has a 0.974 chance of remaining at hidden state 2 for its next hidden state 912. In contrast, if currently at hidden state 2, the user account has a 0.0034 chance of transitioning to hidden state 3 for its next hidden state 912.

As another example, as shown in the transition matrix for the second computing application 902, if a user account associated with the second computing application is currently at hidden state 2 of the current hidden states 920, the user account has a 0.9722 chance of remaining at hidden state 2 for its next hidden state 922. In contrast, if currently at hidden state 2, the user account has a 0.004 chance of transitioning to hidden state 3 for its next hidden state 922.

In some embodiments, the account interaction prediction system 102 generates the transition matrix for the first computing application 901 and the transition matrix for the second computing application 902 for related computing applications intended for different types of client devices. For instance, the first and second computing applications have the same or similar purpose, and similar functionality, with the first computing application intended for desktop use while the second computing application is for mobile use.

Moreover, in some implementations, the account interaction prediction system 102 generates the transition matrix for the first computing application 901 and the transition matrix for the second computing application 902 for different types of applications, both intended for a similar type of client device. For example, the first and second computing applications are different in purpose and function, but both are intended for desktop use (or mobile use).

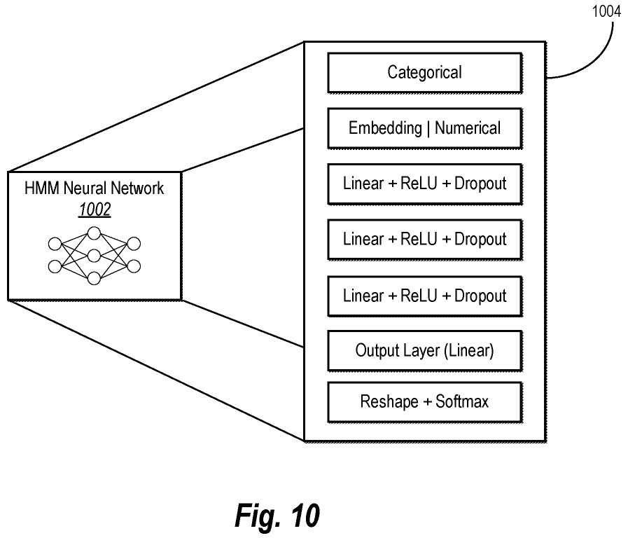

As discussed above, in some embodiments, the account interaction prediction system 102 utilizes one or more neural networks to generate the matrices of the customized hidden Markov models. For instance, FIG. 10 illustrates an example architecture of a neural network of the account interaction prediction system 102 in accordance with one or more embodiments. Specifically, FIG. 10 shows the account interaction prediction system 102 utilizing an HMM neural network 1002 (e.g., the initial state neural network 114, the transition neural network 116, and/or the emission neural network 118).

To illustrate, FIG. 10 depicts an example architecture 1004 of the HMM neural network 1002. In some embodiments, the account interaction prediction system 102 processes user account data through several layers of the HMM neural network 1002. For instance, the account interaction prediction system 102 receives categorical characteristics of the user account data and processes them through an embedding layer to transform the categorical characteristics into numerical vectors. In some cases, the account interaction prediction system 102 receives numerical characteristics of the user account data (e.g., additionally or alternatively to the categorical characteristics). The account interaction prediction system 102 processes the numerical vectors (e.g., including the numerical characteristics) through several linear layers. The linear layers, in one or more embodiments, include rectified linear units (ReLU) and/or dropout (e.g., dilution) functions. In some embodiments, the account interaction prediction system 102 applies reshaping and/or softmax functions to the outputs of the linear layers.

In some embodiments, the account interaction prediction system 102 utilizes a separate HMM neural network 1002 to generate each of the initial state matrix, the transition matrix, and the emission matrix. For instance, as described above, the account interaction prediction system 102 utilizes the initial state neural network 114, the transition neural network 116, and the emission neural network 118 to generate, respectively, these matrices. In some embodiments, the initial state neural network 114, the transition neural network 116, and the emission neural network 118 each have a similar or same architecture as each other. However, in some embodiments, these matrices are trained utilizing different datasets (e.g., an initial state dataset for the initial state neural network 114, a transition dataset for the transition neural network 116, and an emission dataset for the emission neural network 118).

In some implementations, the account interaction prediction system 102 trains the HMM neural network 1002 (e.g., the initial state neural network 114, the transition neural network 116, and/or the emission neural network 118). For instance, the account interaction prediction system 102 inputs historical user account data to the HMM neural network 1002, generates output predictions (e.g., predicted initial hidden states, predicted transition hidden states, or predicted outcome states, as the case may be), and determines a measure of loss. In some embodiments, the account interaction prediction system 102 utilizes a maximum likelihood estimation with a negative log likelihood as the loss function to determine the measure of loss. For example, the loss function is represented as Loss=−log L where L=Σ_{all combinations of x} p(x₁, . . . , xₙ, z₁, . . . , zₙ) indicating the likelihood of a given outcome sequence.

In some implementations, the account interaction prediction system 102 utilizes the measure of loss to adjust (e.g., tune) parameters of the HMM neural network 1002. The account interaction prediction system 102 repeats this tuning process iteratively until the measure of loss is within a satisfactory (e.g., predetermined) threshold.

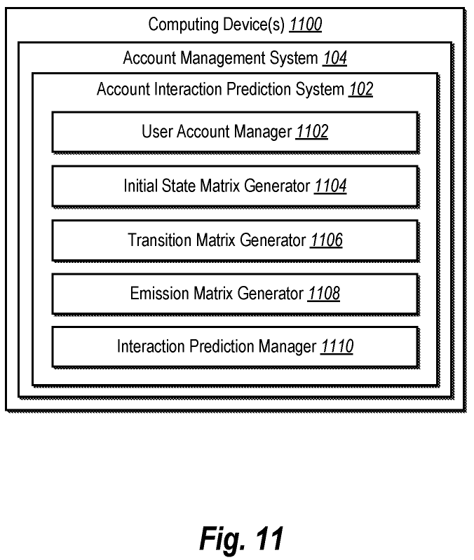

Turning now to FIG. 11, additional detail will be provided regarding components and capabilities of one or more embodiments of the account interaction prediction system 102. In particular, FIG. 11 illustrates an example account interaction prediction system 102 executed by a computing device(s) 1100 (e.g., the server device(s) 106 or the client device 108). As shown by the embodiment of FIG. 11, the computing device(s) 1100 includes or hosts the account management system 104 and/or the account interaction prediction system 102. Furthermore, as shown in FIG. 11, the account interaction prediction system 102 includes a user account manager 1102, an initial state matrix generator 1104, a transition matrix generator 1106, an emission matrix generator 1108, and an interaction prediction manager 1110.

As shown in FIG. 11, the account interaction prediction system 102 includes a user account manager 1102. The user account manager 1102 determines user account data for a user account. For example, in some embodiments, the user account manager 1102 determines user account data associated with one or more computing applications. In particular, in some cases, the user account manager 1102 determines account activity and/or user device activity associated with the one or more computing applications.

In addition, as shown in FIG. 11, the account interaction prediction system 102 includes an initial state matrix generator 1104. In some implementations, the initial state matrix generator 1104 generates an initial state matrix comprising a plurality of initial state values corresponding to a plurality of hidden states of a hidden Markov model for a user account. For example, the initial state matrix generator 1104 extracts initial state features for the user account from user account data, and generates the plurality of initial state values of the initial state matrix from the initial state features.

Moreover, as shown in FIG. 11, the account interaction prediction system 102 includes a transition matrix generator 1106. In some implementations, the transition matrix generator 1106 generates a transition matrix comprising a plurality of transition values corresponding to a plurality of hidden states of a hidden Markov model for a user account. For example, the transition matrix generator 1106 extracts transition features for the user account from user account data, and generates the plurality of transition values of the transition matrix from the transition features.

Furthermore, as shown in FIG. 11, the account interaction prediction system 102 includes an emission matrix generator 1108. In some implementations, the emission matrix generator 1108 generates an emission matrix comprising a plurality of emission values corresponding to a plurality of hidden states of a hidden Markov model for a user account. For example, the emission matrix generator 1108 extracts emission features for the user account from user account data, and generates the plurality of emission values of the emission matrix from the emission features.

Additionally, as shown in FIG. 11, the account interaction prediction system 102 includes an interaction prediction manager 1110. In some implementations, the interaction prediction manager 1110 determines a predicted account interaction metric for a user account in connection with one or more computing applications. For instance, in some embodiments, the interaction prediction manager 1110 determines the predicted account interaction metric utilizing a hidden Markov model including an initial state matrix, a transition matrix, and/or an emission matrix.

Each of the components 1102-1110 of the account interaction prediction system 102 can include software, hardware, or both. For example, the components 1102-1110 can include one or more instructions stored on a computer-readable storage medium and executable by processors of one or more computing devices, such as a client device or server device. When executed by the one or more processors, the computer-executable instructions of the account interaction prediction system 102 can cause the computing device(s) to perform the methods described herein. Alternatively, the components 1102-1110 can include hardware, such as a special purpose processing device to perform a certain function or group of functions. Alternatively, the components 1102-1110 of the account interaction prediction system 102 can include a combination of computer-executable instructions and hardware.

Furthermore, the components 1102-1110 of the account interaction prediction system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1102-1110 may be implemented as a stand-alone application, such as a desktop or mobile application. Furthermore, the components 1102-1110 may be implemented as one or more web-based applications hosted on a remote server. The components 1102-1110 may also be implemented in a suite of mobile device applications or “apps.” To illustrate, the components 1102-1110 may be implemented in an application, including but not limited to ADOBE® EXPERIENCE CLOUD®, ADOBE® MARKETO®, and ADOBE® SENSEI™.

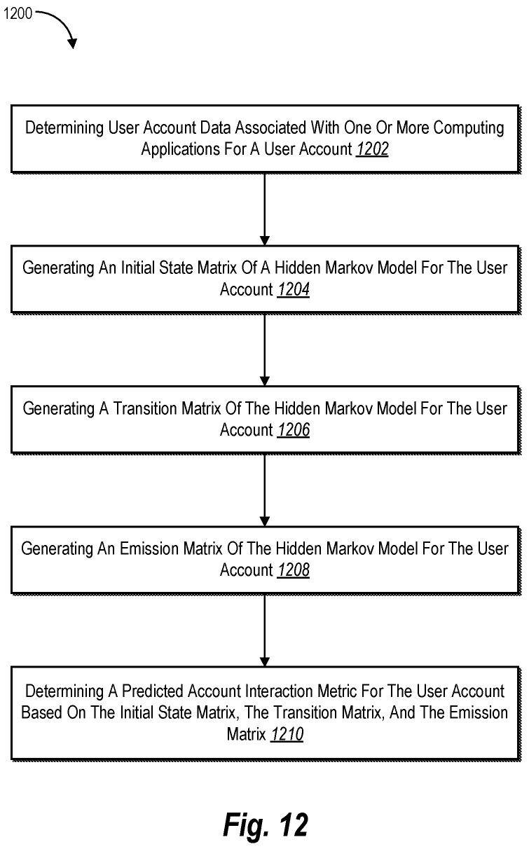

FIGS. 1-11, the corresponding text, and the examples provide a number of different methods, systems, devices, and non-transitory computer-readable media of the account interaction prediction system 102. In addition to the foregoing, one or more embodiments can also be described in terms of flowcharts comprising acts for accomplishing a particular result, as shown in FIG. 12. FIG. 12 may be performed with more or fewer acts. Further, the acts may be performed in differing orders. Additionally, the acts described herein may be repeated or performed in parallel with one another or parallel with different instances of the same or similar acts.

As mentioned, FIG. 12 illustrates a flowchart of a series of acts 1200 for determining a predicted account interaction metric in accordance with one or more embodiments. While FIG. 12 illustrates acts according to one embodiment, alternative embodiments may omit, add to, reorder, and/or modify any of the acts shown in FIG. 12. The acts of FIG. 12 can be performed as part of a method. Alternatively, a non-transitory computer-readable medium can comprise instructions that, when executed by one or more processors, cause a computing device to perform the acts of FIG. 12. In some embodiments, a system can perform the acts of FIG. 12.

As shown in FIG. 12, the series of acts 1200 includes an act 1202 of determining user account data associated with one or more computing applications for a user account, an act 1204 of generating an initial state matrix of a hidden Markov model for the user account, an act 1206 of generating a transition matrix of the hidden Markov model for the user account, an act 1208 of generating an emission matrix of the hidden Markov model for the user account, and an act 1210 of determining a predicted account interaction metric for the user account based on the initial state matrix, the transition matrix, and the emission matrix.

In particular, the act 1202 can include determining, by at least one processor, user account data associated with one or more computing applications for a user account, the act 1204 can include generating, by the at least one processor and based on the user account data, an initial state matrix comprising a plurality of initial state values corresponding to a plurality of hidden states of a hidden Markov model for the user account, the act 1206 can include generating, by the at least one processor and based on the user account data, a transition matrix comprising a plurality of transition values corresponding to the plurality of hidden states of the hidden Markov model for the user account, the act 1208 can include generating, by the at least one processor and based on the user account data, an emission matrix comprising a plurality of emission values corresponding to the plurality of hidden states of the hidden Markov model for the user account, and the act 1210 can include determining, by the at least one processor utilizing the hidden Markov model, a predicted account interaction metric for the user account in connection with the one or more computing applications based on the initial state matrix, the transition matrix, and the emission matrix. In some embodiments, the act 1210 includes determining, by the at least one processor utilizing the hidden Markov model, a predicted account interaction metric for the user account in connection with the one or more computing applications based on the transition matrix and the emission matrix.

In some implementations, the act 1202 includes determining user account data associated with one or more computing applications for a user account; the act 1204 includes generating, utilizing one or more neural networks and based on the user account data, an initial state matrix comprising a plurality of initial state values corresponding to the plurality of hidden states of the hidden Markov model for the user account; the act 1206 includes generating, utilizing the one or more neural networks and based on the user account data, a transition matrix comprising a plurality of transition values corresponding to a plurality of hidden states of a hidden Markov model for the user account; the act 1208 includes generating, utilizing the one or more neural networks and based on the user account data, an emission matrix comprising a plurality of emission values corresponding to the plurality of hidden states of the hidden Markov model for the user account; and the act 1210 includes determining, utilizing the hidden Markov model, a predicted account interaction metric for the user account in connection with the one or more computing applications based on the initial state matrix, the transition matrix, and the emission matrix. In some embodiments, the act 1210 includes determining, utilizing the hidden Markov model, a predicted account interaction metric for the user account in connection with the one or more computing applications based on the transition matrix and the emission matrix.

Additionally, in one or more embodiments, the series of acts 1200 includes wherein generating the initial state matrix comprises: extracting, utilizing an initial state neural network, initial state features for the user account from the user account data; and generating, utilizing the initial state neural network, the plurality of initial state values of the initial state matrix from the initial state features. Moreover, in some embodiments, the series of acts 1200 includes wherein generating the transition matrix comprises: extracting, utilizing a transition neural network, transition features for the user account from the user account data; and generating, utilizing the transition neural network, the plurality of transition values of the transition matrix from the transition features. Furthermore, in some embodiments, the series of acts 1200 includes wherein generating the emission matrix comprises: extracting, utilizing an emission neural network, emission features for the user account from the user account data; and generating, utilizing the emission neural network, the plurality of emission values of the emission matrix from the emission features.

Alternatively, in some implementations, the series of acts 1200 includes wherein generating the initial state matrix comprises generating, utilizing an initial state neural network of the one or more neural networks, the plurality of initial state values of the initial state matrix from extracted initial state features for the user account. Moreover, in some embodiments, the series of acts 1200 includes wherein generating the transition matrix comprises generating, utilizing a transition neural network of the one or more neural networks, the plurality of transition values of the transition matrix from extracted transition features for the user account. Furthermore, in some embodiments, the series of acts 1200 includes wherein generating the emission matrix comprises generating, utilizing an emission neural network of the one or more neural networks, the plurality of emission values of the emission matrix from extracted emission features for the user account.

In some cases, the series of acts 1200 includes determining a second set of user account data associated with the one or more computing applications for a second user account; generating, utilizing the one or more neural networks and based on the second set of user account data, a second transition matrix comprising a second plurality of transition values corresponding to a second plurality of hidden states of a second hidden Markov model for the second user account; generating, utilizing the one or more neural networks and based on the second set of user account data, a second emission matrix comprising a second plurality of emission values corresponding to the second plurality of hidden states of the second hidden Markov model for the second user account; and determining, utilizing the second hidden Markov model, a second predicted account interaction metric for the second user account in connection with the one or more computing applications based on the second transition matrix and the second emission matrix.

Moreover, in some embodiments, the series of acts 1200 includes wherein determining the user account data comprises determining account activity associated with the one or more computing applications for the user account or user device activity of a client device of the user account associated with the one or more computing applications. Alternatively, in one or more embodiments, the series of acts 1200 includes wherein determining the user account data comprises determining account activity associated with the one or more computing applications for the user account.

Furthermore, in some embodiments, the series of acts 1200 includes wherein determining the predicted account interaction metric comprises determining an outcome state of the hidden Markov model based on a hidden state of the plurality of hidden states for the user account according to the plurality of transition values of the transition matrix and the plurality of emission values of the emission matrix. Alternatively, in one or more embodiments, the series of acts 1200 includes wherein determining the predicted account interaction metric comprises determining an outcome state of the hidden Markov model based on a hidden state of the plurality of hidden states for the user account according to the plurality of initial state values of the initial state matrix, the plurality of transition values of the transition matrix, and the plurality of emission values of the emission matrix.

In addition, in some embodiments, the series of acts 1200 includes determining, by the at least one processor utilizing the hidden Markov model, an additional predicted account interaction metric for the user account in connection with the one or more computing applications based on the transition matrix and the emission matrix, wherein the additional predicted account interaction metric corresponds to a second time period different from a first time period of the predicted account interaction metric. Alternatively, in one or more embodiments, the series of acts 1200 includes determining, utilizing the hidden Markov model, an additional predicted account interaction metric for the user account in connection with the one or more computing applications based on the initial state matrix, the transition matrix, and the emission matrix, wherein the additional predicted account interaction metric corresponds to a second time period different from a first time period of the predicted account interaction metric.

Moreover, in some embodiments, the series of acts 1200 includes determining a computing application of the one or more computing applications indicated by the predicted account interaction metric; and generating a message for display at a client device associated with the user account identifying the computing application. Alternatively, in one or more embodiments, the series of acts 1200 includes determining a computing application of the one or more computing applications based on the predicted account interaction metric; and generating a message for display at a client device associated with the user account comprising an indication of a user account action associated with the computing application.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions from a non-transitory computer-readable medium (e.g., memory) and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general purpose computer, special purpose computer, or special purpose processing device to perform a certain function or group of functions. In some embodiments, computer-executable instructions are executed by a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), a web service, Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 13 illustrates a block diagram of an example computing device 1300 that may be configured to perform one or more of the processes described above. One will appreciate that one or more computing devices, such as the computing device 1300 may represent the computing devices described above (e.g., the computing device(s) 1100, the server device(s) 106, or the client device 108). In one or more embodiments, the computing device 1300 may be a mobile device (e.g., a mobile telephone, a smartphone, a PDA, a tablet, a laptop, a camera, a tracker, a watch, a wearable device, etc.). In some embodiments, the computing device 1300 may be a non-mobile device (e.g., a desktop computer or another type of client device). Further, the computing device 1300 may be a server device that includes cloud-based processing and storage capabilities.

As shown in FIG. 13, the computing device 1300 can include one or more processor(s) 1302, memory 1304, a storage device 1306, input/output interfaces 1308 (or “I/O interfaces 1308”), and a communication interface 1310, which may be communicatively coupled by way of a communication infrastructure (e.g., bus 1312). While the computing device 1300 is shown in FIG. 13, the components illustrated in FIG. 13 are not intended to be limiting. Additional or alternative components may be used in other embodiments. Furthermore, in certain embodiments, the computing device 1300 includes fewer components than those shown in FIG. 13. Components of the computing device 1300 shown in FIG. 13 will now be described in additional detail.

In particular embodiments, the processor(s) 1302 includes hardware for executing instructions, such as those making up a computer program. As an example, and not by way of limitation, to execute instructions, the processor(s) 1302 may retrieve (or fetch) the instructions from an internal register, an internal cache, memory 1304, or a storage device 1306 and decode and execute them.

The computing device 1300 includes the memory 1304, which is coupled to the processor(s) 1302. The memory 1304 may be used for storing data, metadata, and programs for execution by the processor(s). The memory 1304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1304 may be internal or distributed memory.

The computing device 1300 includes the storage device 1306 for storing data or instructions. As an example, and not by way of limitation, the storage device 1306 can include a non-transitory storage medium described above. The storage device 1306 may include a hard disk drive (“HDD”), flash memory, a Universal Serial Bus (“USB”) drive or a combination these or other storage devices.

As shown, the computing device 1300 includes one or more I/O interfaces 1308, which are provided to allow a user to provide input to (such as user strokes), receive output from, and otherwise transfer data to and from the computing device 1300. These I/O interfaces 1308 may include a mouse, keypad or a keyboard, a touch screen, camera, optical scanner, network interface, modem, other known I/O devices or a combination of such I/O interfaces 1308. The touch screen may be activated with a stylus or a finger.

The I/O interfaces 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1308 are configured to provide graphical data to a display for presentation to a user. The graphical data may be representative of one or more graphical user interfaces and/or any other graphical content as may serve a particular implementation.

The computing device 1300 can further include a communication interface 1310. The communication interface 1310 can include hardware, software, or both. The communication interface 1310 provides one or more interfaces for communication (such as, for example, packet-based communication) between the computing device and one or more other computing devices or one or more networks. As an example, and not by way of limitation, communication interface 1310 may include a network interface controller (“NIC”) or network adapter for communicating with an Ethernet or other wire-based network or a wireless NIC (“WNIC”) or wireless adapter for communicating with a wireless network, such as a WI-FI. The computing device 1300 can further include the bus 1312. The bus 1312 can include hardware, software, or both that connects components of computing device 1300 to each other.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining, by at least one processor, user account data associated with one or more computing applications for a user account;
generating, by the at least one processor and based on the user account data, a transition matrix comprising a plurality of transition values corresponding to a plurality of hidden states of a hidden Markov model for the user account;
generating, by the at least one processor and based on the user account data, an emission matrix comprising a plurality of emission values corresponding to the plurality of hidden states of the hidden Markov model for the user account; and
determining, by the at least one processor utilizing the hidden Markov model, a predicted account interaction metric for the user account in connection with the one or more computing applications based on the transition matrix and the emission matrix.

2. The computer-implemented method of claim 1, further comprising:
generating, by the at least one processor and based on the user account data, an initial state matrix comprising a plurality of initial state values corresponding to the plurality of hidden states of the hidden Markov model for the user account,
wherein determining the predicted account interaction metric is further based on the initial state matrix.

3. The computer-implemented method of claim 2, wherein generating the initial state matrix comprises:
extracting, utilizing an initial state neural network, initial state features for the user account from the user account data; and
generating, utilizing the initial state neural network, the plurality of initial state values of the initial state matrix from the initial state features.

4. The computer-implemented method of claim 1, wherein generating the transition matrix comprises:
extracting, utilizing a transition neural network, transition features for the user account from the user account data; and
generating, utilizing the transition neural network, the plurality of transition values of the transition matrix from the transition features.

5. The computer-implemented method of claim 1, wherein generating the emission matrix comprises:
extracting, utilizing an emission neural network, emission features for the user account from the user account data; and
generating, utilizing the emission neural network, the plurality of emission values of the emission matrix from the emission features.

6. The computer-implemented method of claim 1, wherein determining the user account data comprises determining account activity associated with the one or more computing applications for the user account or user device activity of a client device of the user account associated with the one or more computing applications.

7. The computer-implemented method of claim 1, wherein determining the predicted account interaction metric comprises determining an outcome state of the hidden Markov model based on a hidden state of the plurality of hidden states for the user account according to the plurality of transition values of the transition matrix and the plurality of emission values of the emission matrix.

8. The computer-implemented method of claim 1, further comprising:
determining, by the at least one processor utilizing the hidden Markov model, an additional predicted account interaction metric for the user account in connection with the one or more computing applications based on the transition matrix and the emission matrix,
wherein the additional predicted account interaction metric corresponds to a second time period different from a first time period of the predicted account interaction metric.

9. The computer-implemented method of claim 1, further comprising:
determining a computing application of the one or more computing applications indicated by the predicted account interaction metric; and
generating a message for display at a client device associated with the user account identifying the computing application.

10. A system comprising:
one or more memory devices comprising one or more neural networks; and
one or more processors configured to cause the system to:
determine user account data associated with one or more computing applications for a user account;
generate, utilizing the one or more neural networks and based on the user account data, a transition matrix comprising a plurality of transition values corresponding to a plurality of hidden states of a hidden Markov model for the user account;
generate, utilizing the one or more neural networks and based on the user account data, an emission matrix comprising a plurality of emission values corresponding to the plurality of hidden states of the hidden Markov model for the user account; and
determine, utilizing the hidden Markov model, a predicted account interaction metric for the user account in connection with the one or more computing applications based on the transition matrix and the emission matrix.

11. The system of claim 10, wherein the one or more processors are further configured to cause the system to:
generate, utilizing the one or more neural networks and based on the user account data, an initial state matrix comprising a plurality of initial state values corresponding to the plurality of hidden states of the hidden Markov model for the user account,
wherein determining the predicted account interaction metric is further based on the initial state matrix.

12. The system of claim 11, wherein generating the initial state matrix comprises generating, utilizing an initial state neural network of the one or more neural networks, the plurality of initial state values of the initial state matrix from extracted initial state features for the user account.

13. The system of claim 10, wherein generating the transition matrix comprises generating, utilizing a transition neural network of the one or more neural networks, the plurality of transition values of the transition matrix from extracted transition features for the user account.

14. The system of claim 10, wherein generating the emission matrix comprises generating, utilizing an emission neural network of the one or more neural networks, the plurality of emission values of the emission matrix from extracted emission features for the user account.

15. The system of claim 10, wherein the one or more processors are further configured to cause the system to:
determine a second set of user account data associated with the one or more computing applications for a second user account;
generate, utilizing the one or more neural networks and based on the second set of user account data, a second transition matrix comprising a second plurality of transition values corresponding to a second plurality of hidden states of a second hidden Markov model for the second user account;
generate, utilizing the one or more neural networks and based on the second set of user account data, a second emission matrix comprising a second plurality of emission values corresponding to the second plurality of hidden states of the second hidden Markov model for the second user account; and
determine, utilizing the second hidden Markov model, a second predicted account interaction metric for the second user account in connection with the one or more computing applications based on the second transition matrix and the second emission matrix.

16. A non-transitory computer-readable medium storing executable instructions that, when executed by a processing device, cause the processing device to perform operations comprising:
determining user account data associated with one or more computing applications for a user account;
generating, based on the user account data, an initial state matrix comprising a plurality of initial state values corresponding to a plurality of hidden states of a hidden Markov model for the user account;
generating, based on the user account data, a transition matrix comprising a plurality of transition values corresponding to the plurality of hidden states of the hidden Markov model for the user account;
generating, based on the user account data, an emission matrix comprising a plurality of emission values corresponding to the plurality of hidden states of the hidden Markov model for the user account; and
determining, utilizing the hidden Markov model, a predicted account interaction metric for the user account in connection with the one or more computing applications based on the initial state matrix, the transition matrix, and the emission matrix.

17. The non-transitory computer-readable medium of claim 16, wherein determining the user account data comprises determining account activity associated with the one or more computing applications for the user account.

18. The non-transitory computer-readable medium of claim 16, wherein determining the predicted account interaction metric comprises determining an outcome state of the hidden Markov model based on a hidden state of the plurality of hidden states for the user account according to the plurality of initial state values of the initial state matrix, the plurality of transition values of the transition matrix, and the plurality of emission values of the emission matrix.

19. The non-transitory computer-readable medium of claim 16, wherein the operations further comprise:
determining, utilizing the hidden Markov model, an additional predicted account interaction metric for the user account in connection with the one or more computing applications based on the initial state matrix, the transition matrix, and the emission matrix,
wherein the additional predicted account interaction metric corresponds to a second time period different from a first time period of the predicted account interaction metric.

20. The non-transitory computer-readable medium of claim 16, wherein the operations further comprise:
determining a computing application of the one or more computing applications based on the predicted account interaction metric; and
generating a message for display at a client device associated with the user account comprising an indication of a user account action associated with the computing application.
